(19) United States
(12) Patent Application Publication
(10) Pub. No.: US 2026/0271130 A1
(43) Pub. Date: Sep. 10, 2026

(54) METHODS, APPARATUSES AND SYSTEMS FOR CELL DISCONTINUOUS TRANSMISSION AND RECEPTION SIGNAL PROCESSING

(71) Applicant: ZTE CORPORATION, Shenzhen (CN)

(72) Inventors: Xuan MA, Shenzhen (CN); Qiujin GUO, Shenzhen (CN); Mengzhu CHEN, Shenzhen (CN); Jun XU, Shenzhen (CN); Bo DAI, Shenzhen (CN); Youjun HU, Shenzhen (CN); Xiaoying MA, Shenzhen (CN); Hong TANG, Shenzhen (CN)

(73) Assignee: ZTE CORPORATION, Shenzhen (CN)

(21) Appl. No.: 19/167,150

(22) PCT Filed: Apr. 6, 2023
(86) PCT No.: PCT/CN2023/086459

§ 371 Date: Sep. 19, 2025

(51) Int. Cl. H04W 76/28; H04B 7/06; H04W 52/02

(52) U.S. Cl. CPC H04W 76/28; H04B 7/0626; H04W 52/0235

(57) ABSTRACT

Methods, apparatus and systems for cell discontinuous transmission and cell discontinuous reception signal processing are described. In one embodiment, a method performed by a first wireless communication device, includes: receiving a first signal to a first wireless communication node; transmitting a second signal to the first wireless communication node, wherein the second signal includes at least one of: a wake up indication; a cell discontinuous reception (DRX) pattern indication indicating a preferred cell DRX pattern; and a cell discontinuous transmission (DTX) and DRX pattern indication indicating a preferred cell DTX/DRX pattern; a timer triggering indication; a signal transmission indication; and a latency delay requirement.

### TECHNICAL FIELD

The disclosure relates generally to wireless communications and, more particularly, to methods, apparatuses and systems for cell discontinuous transmission and reception signal processing.

### BACKGROUND

Discontinuous transmission (DTX) and discontinuous reception (DRX) are techniques that allow user equipment and/or network to power down significant amounts of its internal circuitry for a high percentage of the time when there is no signal/channel transmitted or received. The period of time when the user equipment and/or the network are restricted for transmission or reception is called “inactive time”.

Cell DTX/DRX is introduced to reduce the energy consumption of the entire network. In a cell DTX/DRX configuration, network can transmit or receive data only during cell DTX/DRX active time, and only a few necessary signals or channels are transmitted and received during cell DTX/DRX inactive times. For a cell DTX/DRX, the longer the inactive duration is, the larger the energy saving will be. However, long inactive times may affect user experience in the cell. For example, during a long inactive time, user equipment (UE) may experience longer delay times when reacting to a sudden burst due to few activated signals or channels in the inactive time. Therefore, there is a need to improve the user experience in the cell DTX/DRX while maintaining reasonable energy saving gain by defining UE behaviors in the cell DRX/DTX scheme.

### SUMMARY

The exemplary embodiments disclosed herein are directed to solving the issues relating to one or more of the problems presented in the prior art, as well as providing additional features that will become readily apparent by reference to the following detailed description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

In some embodiments, a method performed by a first wireless communication device, includes: receiving a first signal comprising configuration information to at least one first wireless communication device from a plurality of wireless communication node; transmitting at least a second signal to the wireless communication node, wherein the at least one second signal includes at least one of: a wake up indication; a cell discontinuous reception (DRX) pattern indication indicating a preferred cell DRX pattern; and a cell discontinuous transmission (DTX) and DRX pattern indication indicating a preferred cell DTX and DRX pattern; a timer triggering indication; a signal transmission indication; and a latency delay requirement.

In some embodiments, the first signal includes at least one of: a radio resource control (RRC) signal; a downlink control information (DCI) signal; a media access control (MAC) control element (CE) signal; and a low power wake up signal (LP-WUS), wherein the LP-WUS signal comprises at least one of: a preamble; a data part; and a cyclic redundancy check (CRC) attachment.

In some embodiments, the first signal can be a feedback signal from the first wireless communication node in response to the second signal.

In some embodiments, the first signal comprises a configuration information includes at least one of: one or more cell DTX patterns, wherein each of the one or more cell DTX patterns comprise at least one of: a cell DTX start offset, a cell DTX cycle, a cell DTX ON duration timer, and a cell DTX inactivity timer; one or more cell DRX patterns, wherein each of the one or more cell DRX patterns comprise at least one of: a cell DRX start offset, a cell DRX cycle, a cell DRX ON duration timer, and a cell DRX inactivity timer; and one or more cell DTX and DRX patterns, wherein each of the one or more cell DTX/DRX patterns comprise at least one of: a cell DTX/DRX start offset, a cell DTX/DRX cycle, a cell DTX/DRX ON duration timer associated with a cell DTX/DRX ON duration, and a cell DTX/DRX inactivity timer. In some embodiments, the first signal is transmitted when at least one of the following conditions is met: a wireless communication device supports UE capability of cell DTX; a wireless communication device supports UE capability of cell DRX; a second signal is transmitted by a wireless communication device or received by a wireless communication node; a cell DRX pattern is changed; a cell DTX pattern is changed; and a timer is activated, wherein the timer comprises at least one of: a cell DTX on duration timer; a cell DTX inactivity timer; a cell DRX on duration timer; a cell DRX inactivity timer; a cell DTX and DRX on duration timer; and a cell DTX and DRX inactivity timer.

In some embodiments, the first signal further comprises an indication information including at least one of: activating and/or deactivating a cell DTX pattern for a group of wireless communication devices; activating and/or deactivating a cell DRX pattern for a group of wireless communication devices; an information block carrying information for a wireless communication device of a group of wireless communication devices, wherein the information comprises a wake-up indication, a signal transmission indication, a timer triggering indication, a resource parameter, a flag indicating whether the one or more fields in the DCI are reinterpreted or an indication indicating a type of a power offset to be used, a field to indicate selected power offsets, a field to indicate one or more updated CSI resources, a field to indicate a start offset of a cell DTX/DRX cycle, or user equipment, UE, connected mode discontinuous reception, CDRX, configuration related information, a field to indicate a number of ports used for at least one of a CSI measurement or a CSI report, one or more CSI-RS resource identifiers, one or more CSI-RS resource set identifiers, one or more CSI-ResourceConfig identifiers, and a field to indicate the activation or deactivation of the TCI states in the TCI state set; wherein the resource parameter includes at least one of the number of ports, port indices indication, group indication, power offset, an index, TCI (transmission configuration indicator), CDM (code division multiplexing), resource mapping, CDM group index, frequency domain resource, time domain resource, a group index.

In some embodiments, the second signal comprises at least one of: a physical random access channel (PRACH) preamble based signal; a physical uplink control channel (PUCCH); a scheduling request (SR); a buffer status report (BSR); a sequence or preamble based signal. The PRACH preamble based signal is associated with at least one of: a preamble format; a sequence generation method; a preamble index; a cell DRX pattern index; and a cell DTX/DRX pattern index.

In some embodiments, the at least one second signal is received according to a plurality of second signal transmission occasions, wherein the plurality of second signal transmission occasions is associated with at least one of: a random access channel (RACH) occasion; a cell DRX configuration; a cell DTX/DRX configuration; a start point and a periodicity; and a time window, wherein the time window is associated with at least one of a start point, an offset, or a periodicity.

In some embodiments, the wakeup indication includes at least one of: a first indication for starting a cell DRX on duration timer; a second indication for starting a cell DTX and DRX on duration timer; a third indication for not starting the cell DRX on duration timer; and a fourth indication for not starting the cell DTX and DRX on duration timer.

In some embodiments, the at least one second signal further includes at least one of: a cell DRX pattern indication field, wherein the cell DRX pattern indication field includes a first bitmap including a first plurality of bits, wherein each of the first plurality of bits is associated with a corresponding first cell DRX pattern; and a cell DTX and DRX pattern indication field, wherein the cell DTX and DRX pattern indication field includes a second bitmap including a second plurality of bits, wherein each of the second plurality of bits is associated with a corresponding first cell DTX pattern or a corresponding second DRX pattern.

In some embodiments, the timer triggering indication comprises at least one of: an indication to indicate to start a cell DRX inactivity timer; an indication to indicate to restart a cell DRX inactivity timer; an indication to indicate to stop a cell DRX inactivity timer; an indication to indicate to start a cell DTX/DRX inactivity timer; an indication to indicate to restart a cell DTX/DRX inactivity timer; an indication to indicate to stop a cell DTX inactivity timer.

In some embodiments, the signal transmission indication comprises at least one of: an indication to indicate to transmit a third signal; an indication to indicate not to transmit a third signal; an indication to indicate to receive a fourth signal; an indication to indicate not to receive a fourth signal; wherein the third signal comprises at least one of: a PUCCH, a physical uplink shared channel (PUSCH), a hybrid automatic repeat request acknowledgement (HARQ-ACK), a channel state information (CSI) report, a sounding reference signal (SRS), a Configured Grant Physical Uplink Shared Channel (CG-PUSCH); wherein the fourth signal comprises at least one of: a PDCCH, a PDSCH, a semi-persistent scheduling (SPS), a CSI reference signal (CSI-RS), a semi-persistent CSI-RS, an aperiodic CSI-RS, a remote interference management reference signal (RIM-RS) , a positioning reference signal (PRS), a synchronization signal physical broadcast channel (SS/PBCH) block, a phase-tracking reference signal (PT-RS), a secondary synchronization signal (SSS), a primary synchronization signal (PSS).

### BRIEF DESCRIPTION OF THE DRAWINGS

Various exemplary embodiments of the present disclosure are described in detail below with reference to the following Figures. The drawings are provided for purposes of illustration only and merely depict exemplary embodiments of the present disclosure to facilitate the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A illustrates an exemplary wireless communication network, in accordance with some embodiments of the present disclosure.

FIG. 1B illustrates a block diagram of an exemplary wireless communication system, in accordance with some embodiments of the present disclosure.

FIG. 2 illustrates a signaling diagram between a base station and a user equipment for performing cell DTX/DRX signal processing, in accordance with some embodiments.

FIG. 3 illustrates an example of two cell DRX patterns, in accordance with some embodiments.

FIG. 4 illustrates another signaling diagram between a base station and a user equipment for performing cell DTX/DRX signal processing, in accordance with some embodiments.

FIG. 5 illustrates an example of a cell DRX inactivity timer used in a cell DRX pattern, in accordance with some embodiments.

FIG. 6 illustrates yet another signaling diagram between a base station and a user equipment for performing cell DTX/DRX signal processing, in accordance with some embodiments.

FIG. 7 illustrates still another signaling diagram between a base station and a user equipment for performing cell DTX/DRX signal processing, in accordance with some embodiments.

FIG. 8 illustrates still another signaling diagram between a base station and two user equipments for performing cell DTX/DRX signal processing, in accordance with some embodiments.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

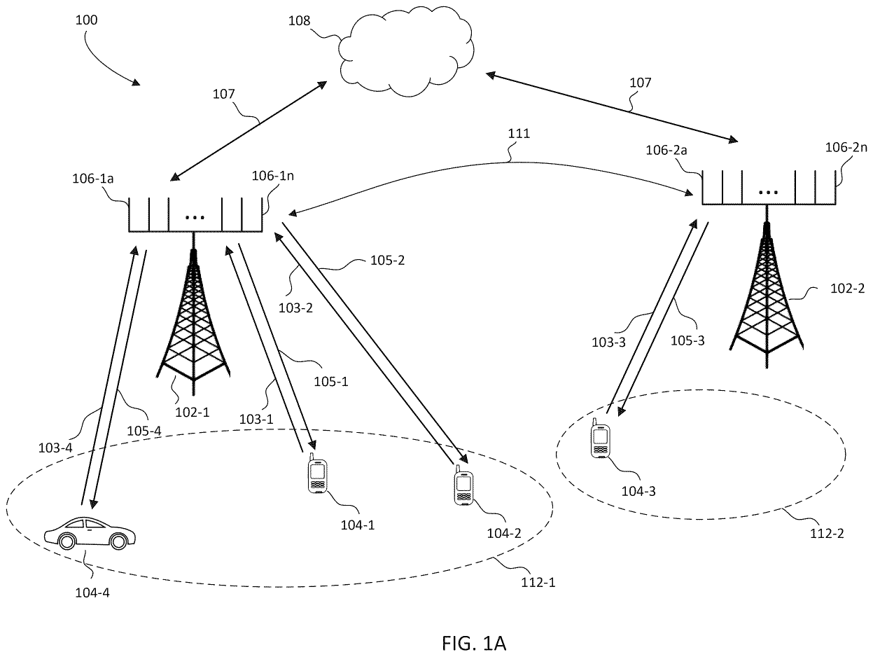

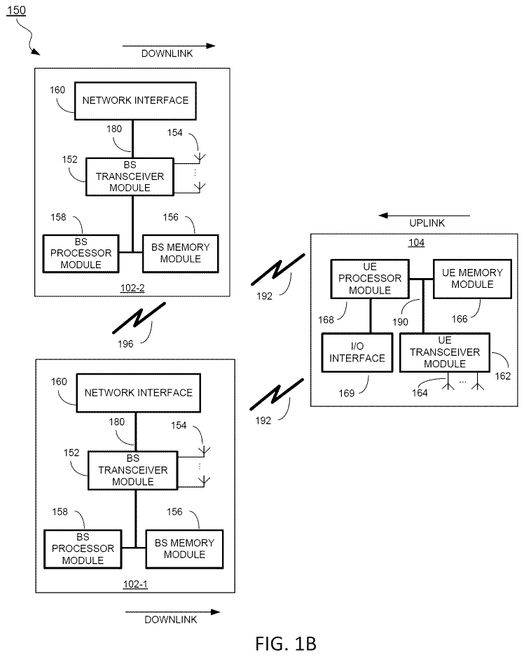

FIG. 1A illustrates an exemplary wireless communication network 100, in accordance with some embodiments of the present disclosure. In a wireless communication system, a network side communication node or a base station (BS) 102 can be a node B, an E-UTRA Node B (also known as Evolved Node B, eNodeB or eNB), a New Generation eNB (ng-eNB), a gNodeB (also known as gNB) in new radio (NR) technology, a pico station, a femto station, or the like. A terminal side communication device or a user equipment (UE) 104 can be a long range communication system like a mobile phone, a smart phone, a personal digital assistant (PDA), tablet, laptop computer, or a short range communication system such as, for example a wearable device, a vehicle with a vehicular communication system and the like. A network communication node and a terminal side communication device are represented by a BS 102 and a UE 104, respectively, and in all the embodiments in this disclosure hereafter, and are generally referred to as “communication nodes” and “communication device,” respectively, herein. Such communication nodes and communication devices are capable of wireless communications, in accordance with various embodiments of the invention. It is noted that all the embodiments are merely preferred examples and are not intended to limit the present disclosure. Accordingly, it is understood that the system may include any desired combination of BSs 102 and UEs 104, while remaining within the scope of the present disclosure.

Referring to FIG. 1A, the wireless communication network 100 includes a first BS 102-1, a second BS 102-2, a first UE 104-1, a second UE 104-2, a third UE 104-3, and a fourth UE 104-4. In some embodiments, the first BS 102-1 and the second BS 102-2 comprise a first plurality of antennas 106-1a to 106-1n and a second plurality of antennas 106-2a to 106-2n, respectively. The first plurality of antennas 106-1a to 106-1n may communicate with one or more of the plurality of UEs 104 to form a first multiple-in-multiple-out (MIMO) system, and the second plurality of antennas 106-2a to 106-2n may communicate with one of more of the plurality of UEs 104 to form a second MIMO system.

In some embodiments, the plurality of UEs 104 may form direct communication links, such as uplink channels 103-1, 103-2, 103-3, and 103-4 and downlink channels 105-1, 105-2, 105-3, and 105-4 with the first BS 102-1 and/or the second BS 102-2. The direct communication channels between the plurality of UEs 104 and one or more of the BS's 102 can be through interfaces such as an Uu interface, which is also known as E-UTRAN air interface. In some embodiments, the UE 104 comprises a plurality of transceivers, which enables the UE 104 to support multi connectivity so as to receive data simultaneously from the first BS 102-1 and the second BS 102-2. Each of the first BS 102-1 and the second BS 102-2 is connected to a core network (CN) 108 on a user plane (UP) through an external interface 107, e.g., an Iu interface, an NG-U interface, or an S1-U interface. In some embodiments, the CN 108 is one of the following: an Evolved Packet Core (EPC) and a 5G Core Network (5GC). In some embodiments, the CN 108 further comprises at least one of the following: Access and Mobility Management Function (AMF), User Plane Function (UPF), and System Management Function (SMF). In some embodiments, the UEs 104-1, 104-2 and 104-4 are within a cell 112-1 covered by the BS 102-1, and the UE 104-3 is within a cell 112-2 covered by the BS 102-2.

A direct communication channel 111 between the first BS 102-1 and the second 102-2 is through an X2 interface. In some embodiments, a BS (e.g., a gNB) is split into a Distributed Unit (DU) and a Central Unit (CU) on the UP, between which the direct communication is through a F1-U interface. In some embodiments, a CU of the second BS 102-2 can be further split into a Control Plane and a User Plane (UP), between which the direct communication is through an E1 interface. Hereinafter in the present disclosure, an Xx interface is used to describe one of the following interfaces, the NG interface, the S1 interface, the X2 interface, the Xn interface, the F1 interface, and the E1 interface. When an Xx interface is established between two nodes, the two nodes can transmit control signaling on the control panel and/or data on the UP.

FIG. 1B illustrates a block diagram of an exemplary wireless communication system 150, in accordance with some embodiments of the present disclosure. The system 150 may include components and elements configured to support known or conventional operating features that need not be described in detail herein. In some embodiments, the system 150 can be used to transmit and receive data symbols in a wireless communication environment such as the wireless communication network 100 of FIG. 1A, as described above.

The system 150 generally includes a first BS 102-1, a second BS 102-2, and a UE 104, collectively referred to as BS 102 and UE 104 below for ease of discussion. The first BS 102-1 and the second BS 102-2 each comprises a BS transceiver module 152, a BS antenna array 154, a BS memory module 156, a BS processor module 158, and a network interface 160. In the illustrated embodiment, each module of the BS 102 is coupled and interconnected with one another as necessary via a data communication bus 180. The UE 104 comprises a UE transceiver module 162, a UE antenna 164, a UE memory module 166, a UE processor module 168, and an I/O interface 169. In the illustrated embodiment, each module of the UE 104 is coupled and interconnected with one another as necessary via a data communication bus 190. The BS 102 communicates with the UE 104 via a communication channel 192, which can be any wireless channel suitable for transmission of data as described herein.

As would be understood by persons of ordinary skill in the art, the system 150 may further include any number of BS's, UE's or modules other than those shown in FIG. 1B. Those skilled in the art will understand that the various illustrative blocks, modules, circuits, and processing logic described in connection with the embodiments disclosed herein may be implemented in hardware, computer-readable software, firmware, or any practical combination thereof. To clearly illustrate this interchangeability and compatibility of hardware, firmware, and software, various illustrative components, blocks, modules, circuits, and steps are described generally in terms of their functionality. Whether such functionality is implemented as hardware, firmware, or software depends upon the particular application and design constraints imposed on the overall system. Those familiar with the concepts described herein may implement such functionality in a suitable manner for each particular application, but such implementation decisions should not be interpreted as limiting the scope of the present invention.

A wireless transmission from a transmitting antenna of the UE 104 to a receiving antenna of the BS 102 is known as an uplink (UL) transmission, and a wireless transmission from a transmitting antenna of the BS 102 to a receiving antenna of the UE 104 is known as a downlink (DL) transmission. In accordance with some embodiments, the UE transceiver 162 may be referred to herein as an “uplink” transceiver 162 that includes a radio frequency (RF) transmitter and receiver circuitry that is each coupled to the UE antenna 164. A duplex switch (not shown) may alternatively couple the uplink transmitter or receiver to the uplink antenna in time duplex fashion. Similarly, in accordance with some embodiments, the BS transceiver 152 may be referred to herein as a “downlink” transceiver 152 that includes RF transmitter and receiver circuitry that are each coupled to the antenna array 154. A downlink duplex switch may alternatively couple the downlink transmitter or receiver to the downlink antenna array 154 in time duplex fashion. The operations of the two transceivers 152 and 162 are coordinated in time such that the uplink receiver is coupled to the uplink UE antenna 164 for reception of transmissions over the wireless communication channel 192 at the same time that the downlink transmitter is coupled to the downlink antenna array 154. Preferably, there is close synchronization timing with only a minimal guard time between changes in duplex direction. The UE transceiver 162 communicates through the UE antenna 164 with the BS 102 via the wireless communication channel 192. The BS transceiver 152 communications through the BS antenna 154 of a BS (e.g., the first BS 102-1) with the other BS (e.g., the second BS 102-2) via a wireless communication channel 196. The wireless communication channel 196 can be any wireless channel or other medium known in the art suitable for direct communication between BSs.

The UE transceiver 162 and the BS transceiver 152 are configured to communicate via the wireless data communication channel 192, and cooperate with a suitably configured RF antenna arrangement 154/164 that can support a particular wireless communication protocol and modulation scheme. In some exemplary embodiments, the UE transceiver 162 and the BS transceiver 152 are configured to support industry standards such as the Long Term Evolution (LTE) and emerging 5G standards (e.g., NR), and the like. It is understood, however, that the invention is not necessarily limited in application to a particular standard and associated protocols. Rather, the UE transceiver 162 and the BS transceiver 152 may be configured to support alternate, or additional, wireless data communication protocols, including future standards or variations thereof.

The processor modules 158 and 168 may be implemented, or realized, with a general purpose processor, a content addressable memory, a digital signal processor, an application specific integrated circuit, a field programmable gate array, any suitable programmable logic device, discrete gate or transistor logic, discrete hardware components, or any combination thereof, designed to perform the functions described herein. In this manner, a processor module may be realized as a microprocessor, a controller, a microcontroller, a state machine, or the like. A processor module may also be implemented as a combination of computing devices, e.g., a combination of a digital signal processor and a microprocessor, a plurality of microprocessors, one or more microprocessors in conjunction with a digital signal processor core, or any other such configuration.

Furthermore, the steps of a method or algorithm described in connection with the embodiments disclosed herein may be embodied directly in hardware, in firmware, in a software module executed by processor modules 158 and 168, respectively, or in any practical combination thereof. The memory modules 156 and 166 may be realized as RAM memory, flash memory, ROM memory, EPROM memory, EEPROM memory, registers, a hard disk, a removable disk, a CD-ROM, or any other form of storage medium known in the art. In this regard, the memory modules 156 and 166 may be coupled to the processor modules 158 and 168, respectively, such that the processors modules 158 and 168 can read information from, and write information to, memory modules 156 and 166, respectively. The memory modules 156 and 166 may also be integrated into their respective processor modules 158 and 168. In some embodiments, the memory modules 156 and 166 may each include a cache memory for storing temporary variables or other intermediate information during execution of instructions to be executed by processor modules 158 and 168, respectively. The memory modules 156 and 166 may also each include non-volatile memory for storing instructions to be executed by the processor modules 158 and 168, respectively.

The network interface 160 generally represents the hardware, software, firmware, processing logic, and/or other components of the base station 102 that enable bi-directional communication between BS transceiver 152 and other network components and communication nodes configured to communication with the BS 102. For example, network interface 160 may be configured to support internet or WiMAX traffic. In a typical deployment, without limitation, network interface 160 provides an 802.3 Ethernet interface such that BS transceiver 152 can communicate with a conventional Ethernet based computer network. In this manner, the network interface 160 may include a physical interface for connection to the computer network (e.g., Mobile Switching Center (MSC)). The terms “configured for” or “configured to” as used herein with respect to a specified operation or function refers to a device, component, circuit, structure, machine, signal, etc. that is physically constructed, programmed, formatted and/or arranged to perform the specified operation or function. The network interface 160 could allow the BS 102 to communicate with other BSs or a CN over a wired or wireless connection.

Referring again to FIG. 1A, as mentioned above, the BS 102 repeatedly broadcasts system information associated with the BS 102 to one or more UEs 104 so as to allow the UEs 104 to access the network within the cells where the BS 102 is located, and in general, to operate properly within the cell. Plural information such as, for example, downlink and uplink cell bandwidths, downlink and uplink configuration, cell information, configuration for random access, etc., can be included in the system information. Typically, the BS 102 broadcasts a first signal carrying some major system information, for example, configuration of the cell where the BS 102 is located through a Physical Broadcast Channel (PBCH). For purposes of clarity of illustration, such a broadcasted first signal is herein referred to as “first broadcast signal.” It is noted that the BS 102 may subsequently broadcast one or more signals carrying some other system information through respective channels (e.g., a Physical Downlink Shared Channel (PDSCH)).

Referring again to FIG. 1B, in some embodiments, the major system information carried by the first broadcast signal may be transmitted by the BS 102 in a symbol format via the communication channel 192 (e.g., a PBCH). In accordance with some embodiments, an original form of the major system information may be presented as one or more sequences of digital bits and the one or more sequences of digital bits may be processed through plural steps (e.g., coding, scrambling, modulation, mapping steps, etc.), all of which can be processed by the BS processor module 158, to become the first broadcast signal. Similarly, when the UE 104 receives the first broadcast signal (in the symbol format) using the UE transceiver 162, in accordance with some embodiments, the UE processor module 168 may perform plural steps (de-mapping, demodulation, decoding steps, etc.) to estimate the major system information such as, for example, bit locations, bit numbers, etc., of the bits of the major system information. The UE processor module 168 is also coupled to the I/O interface 169, which provides the UE 104 with the ability to connect to other devices such as computers. The I/O interface 169 is the communication path between these accessories and the UE processor module 168.

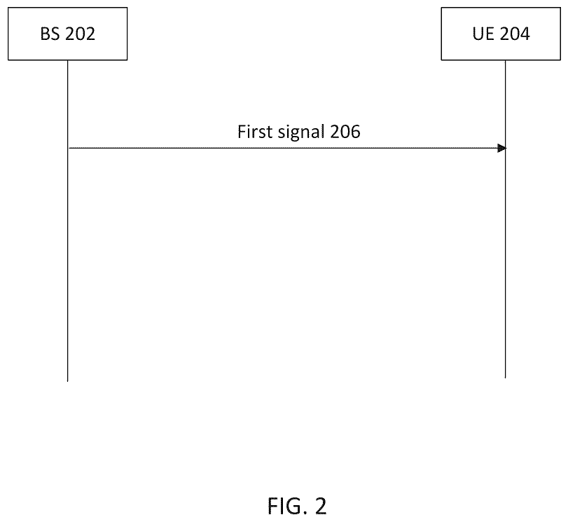

FIG. 2 illustrates a signaling diagram between a BS 202 and a UE 204 for performing cell DTX/DRX signal processing, in accordance with some embodiments. In some embodiments, the BS 202 may be configured to transmit a first signal 206 to the UE 204 for further cell DTX/DRX processing. Although an example of one UE 204 is shown in FIG. 2, the present disclosure is not limited to one single UE, and the BS 202 may transmit first signal 206 to a plurality of UEs within a cell covered by the BS 202.

In some embodiments, a wireless communication node transmits the first signal 206, and/or a wireless communication device receives the first signal 206.

In some embodiments, a wireless communication node transmits the first signal 206, and/or a wireless communication device receives the first signal 206, and the wireless communication device transmits a second signal 406.

In some embodiments, the first signal is a DCI used to indicate indication information for a group of wireless communication devices or all of the wireless communication devices in the serving cell. Wherein the all of the wireless communication devices represents the wireless communication devices supporting the user equipment, UE, capabilities or UE features of cell DTX and/or cell DRX or all of the Release-18 UEs in the serving cell.

In some embodiments, the first signal comprises an indication information including at least one of the followings: activating and/or deactivating a cell DTX pattern; activating and/or deactivating a cell DRX pattern; and/or one or a plurality of information blocks.

In some embodiments, an information block carrying the indication information for a wireless communication device. In some embodiments, the number of information block is equal to the number of wireless communication device in the group of wireless communication devices. In some embodiments, each information block carrying the indication information for one wireless communication device of the group of wireless communication devices.

In some embodiments, the indication information comprises a wake-up indication, a signal transmission indication, a timer triggering indication, a resource parameter, a flag indicating whether the one or more fields in the DCI are reinterpreted or an indication indicating a type of a power offset to be used, a field to indicate selected power offsets, a field to indicate one or more updated CSI resources, a field to indicate a start offset of a cell DTX/DRX cycle, or user equipment, UE, connected mode discontinuous reception, CDRX, configuration related information, a field to indicate a number of ports used for at least one of a CSI measurement or a CSI report, one or more CSI-RS resource identifiers, one or more CSI-RS resource set identifiers, one or more CSI-ResourceConfig identifiers, and a field to indicate the activation or deactivation of the TCI states in the TCI state set.

In some embodiments, the resource parameter is related to spatial domain resource configuration. In some embodiments, the resource parameter includes at least one of: the number of ports, wherein the indication information means number of CSI-RS ports; port indices indication, wherein the indication information indicates one or more port indexes which are selected/activated; a number of a value, wherein the indication information is one of: a number of CSI reports, or a number of antenna muting patterns, or number of RS resource associated with a CSI report configuration, a number of PUCCH resource associated with a CSI report configuration. group indication, a scaling factor, wherein the indication information is greater than or equal to equal and less than 10. For example, ½, ¼, ⅛, ⅓, ⅜, 1, 2, 3, 4, 8. In some embodiments, the scaling factor is used to determine a second number of ports according to a first number of ports; power offset, wherein the indication information corresponds to powerControlOffset or powerControlOffsetSS; In some embodiments, powerControlOffset is the assumed ratio of PDSCH EPRE to NZP CSI-RS EPRE when UE derives CSI feedback and takes values in the range of [−8, 15] dB with 1 dB step size. In some embodiments, powerControlOffsetSS is the assumed ratio of NZP (Non-zero power) CSI-RS EPRE to SS/PBCH block EPRE (Energy per resource element)); an index, for example, the indication information is a CRI(CSI-RS Resource Indicator), a resource set ID, a resource setting ID; TCI(transmission configuration indicator); CDM(code division multiplexing); resource mapping, for example, N1 corresponds to a number of ports in a first dimension and N2 corresponds to a number of ports in a second dimension; CDM group index; frequency domain resource; time domain resource; a group index. In some embodiments, each information block indicates indication information for a group of wireless communication devices in a bitmap. In some embodiments, each information block indicates a resource parameter in a bitmap. In some embodiments, each bit in a bitmap associated with one or more port index, and the value of the bit indicates whether the corresponding ports are active or valid or indicated.

In some embodiments, a UE 204 receives configuration information from the BS 202, the configuration information includes at least one of: one or more cell DTX patterns, one or more cell DRX patterns, one or more cell DTX/DRX patterns, a cell DTX/DRX pattern indication, and a cell DRX pattern indication. The term “one or more DTX/DRX patterns” may be referred to as one or more discontinuous patterns that include both DTX and DRX patterns. Each of the one or more cell DTX patterns may comprise at least one of: a cell DTX start offset, a cell DTX cycle, a cell DTX ON duration timer associated with a cell DTX ON duration, and a cell DTX inactivity timer, each of the one or more cell DRX patterns may comprise at least one of: a cell DRX start offset, a cell DRX cycle, a cell DRX ON duration timer associated with a cell DRX ON duration, and a cell DRX inactivity timer, and each of the one or more cell DTX/DRX patterns may comprise at least one of: a cell DTX/DRX start offset, a cell DTX/DRX cycle, a cell DTX/DRX ON duration timer associated with a cell DTX/DRX ON duration, and a cell DTX/DRX inactivity timer. The purpose of the configuration is for the BS 202 to communicate with the UE 204 and provide one or more cell DRX patterns and/or one or more DTX/DRX patterns, such that communication is only activated during a cell DRX ON duration or a DTX/DRX ON duration in a cell DRX cycle or a cell DTX/DRX cycle. In this way, power consumption incurred during the communication can be reduced.

In some embodiments, the cell DTX/DRX can also be written as cell DRX/DTX, which has the same meaning without substantial difference.

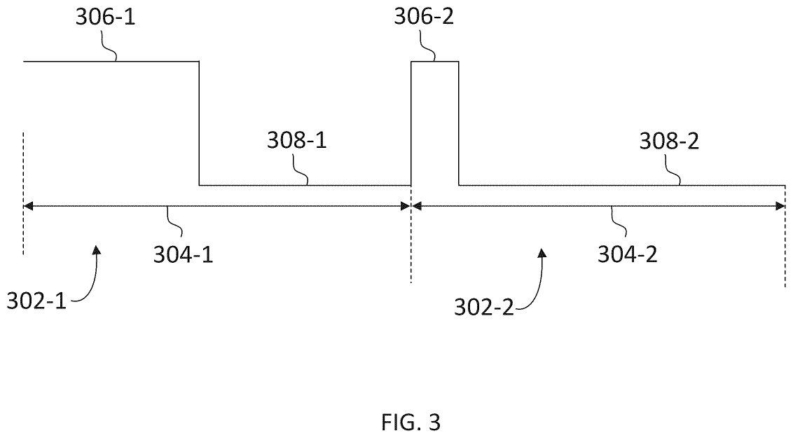

In some embodiments, the BS 202 transmits the first signal 206 to the UE 204 when at least one of the following conditions is met: a wireless communication device supports UE capability of cell DTX; and/or a wireless communication device supports UE capability of cell DRX; a second signal is transmitted by a wireless communication device or received by a wireless communication node; a cell DTX pattern will be changed; a cell DRX pattern will be changed; a cell DTX/DRX pattern will be changed; a start offset will be changed, wherein the start offset comprises at least one of a cell DTX start offset, a cell DRX start offset, a cell DTX/DRX start offset; a timer will be activated, wherein the timer comprises at least one of: a cell DTX on duration timer; a cell DTX inactivity timer; a cell DRX ON duration timer, a cell DRX inactivity timer, a cell DTX/DRX ON duration timer, and a cell DTX/DRX inactivity timer. As used herein, “cell DRX ON duration timer” means a timer that counts the cell DRX on duration in a specific cell DRX cycle. The details of the cell DRX on duration and the cell DRX cycle will be described in further detail below with reference to FIG. 3. “Cell DRX inactivity timer” means a timer that counts a DRX inactivity duration within a specific cell DRX cycle, wherein the DRX inactivity timer may be triggered in the specific cell DRX cycle. In the DRX inactivity duration, the communication between the BS 202 and the UE 204 is active. In some embodiments, the DRX inactivity duration is associated with the UE request.

FIG. 3 illustrates an example of two cell DRX patterns, in accordance with some embodiments. In some embodiments, a first cell DRX pattern 302-1 comprises a cell DRX cycle 304-1, a cell DRX ON duration 306-1 and a cell DRX OFF duration 308-1, and a second cell DRX pattern 302-2 comprises a cell DRX cycle 304-2, a cell DRX ON duration 306-2 and a cell DRX OFF duration 308-2. In one embodiment, the cell DRX cycle 304-1 has the same duration as the cell DRX cycle 304-2. In another embodiment, the cell DRX cycle 304-1 and the cell DRX cycle 304-2 have different durations. In yet another embodiment, the cell DRX ON duration 306-1 is different from the cell DRX ON duration 306-2, and the cell DRX OFF duration 308-1 is different from the cell DRX OFF duration 308-2. In some embodiments, information on one or more desired cell DRX patterns and/or one or more desired cell DTX/DRX patterns may be indicated by the UE 204 and transmitted to the BS 202.

Although an example of two cell DRX patterns is shown in FIG. 3, the present disclosure is not limited to two cell DRX patterns, and a different number of cell DRX patterns, one or more cell DTX patterns, or one or more cell DTX/DRX patterns with a similar diagram as shown in FIG. 3 can be used in the configuration information 206. As would be understood by persons of ordinary skill in the art, cell DTX patterns can have similar ON and OFF durations as those illustrated in FIG. 3. It is further understood that cell DTX patterns can be, but need not be, similar to the cell DRX patterns for a session established between the BS 202 and UE 204.

In some embodiments, when one or more cell DTX patterns are activated during communication, the downlink (DL) transmission from the BS 202 to the UE 204 is controlled by the one or more cell DTX patterns, and the DL transmission only occurs in cell DTX ON durations, while the uplink (UL) traffic from the UE 204 to the BS 202 is not impacted by the one or more cell DTX patterns. In some other embodiments, when one or more cell DRX patterns are activated during communication, the UL transmission from the UE 204 to the BS 202 is controlled by the one or more cell DRX patterns, and the UL transmission only occurs in cell DRX ON durations, while the DL traffic from the BS 202 to the UE 204 is not impacted by the one or more cell DRX patterns. In yet some other embodiments, when both DTX and DRX patterns are activated during communication, DL transmission from the BS 202 to the UE 204 can only occur in cell DTX ON durations, and UL transmission from the UE 204 to the BS 202 can only occur in cell DRX ON durations.

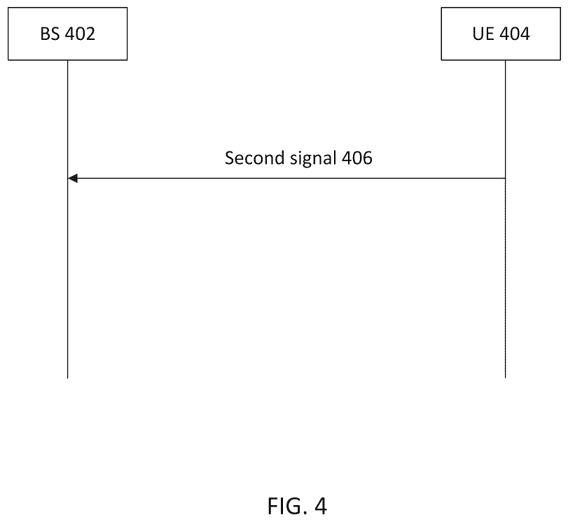

FIG. 4 illustrates another signaling diagram between a BS 402 and a UE 404 for performing cell DTX/DRX signal processing, in accordance with some embodiments. In some embodiments, the UE 404 may be configured to transmit a second signal 406 to the BS 402 on a plurality of second signal transmission occasions for further cell DTX/DRX processing. The plurality of second signal transmission occasions may be referred to as the conditions and timings for transmitting the second signal 406. In some embodiments, the UE 404 may receive the first signal 206 from the BS 402 after transmitting the second signal 406. In some embodiments, the UE 404 may transmit the second signal 406 after receiving the first signal 206 and in response to the information contained in the first signal 206. As discussed in further detail below, the second signaling requests specific cell DTX, cell DRX or cell DTX/DRX patterns be configured by the BS 402 to optimize or improve user experience (e.g., signal latency) during data transmissions as measured or determined by the UE 404. If the second signal 406 is transmitted after the first signal 206, the second signal 406 can contain information to adjust the cell DTX, cell DRX and cell DTX/DRX previously configured by the BS 402. If the second signal 406 is transmitted first, the second signal 406 contains information to request the specific cell DTX, cell DRX or cell DTX/DRX patterns desired. In accordance with some embodiments, the BS 402 can grant the request from the UE 404 based on various factors (e.g., available communication resources, quality of service (QoS) parameters associated with the UE 404, etc.).

In some embodiments, the second signal 406 comprises at least one desired cell DRX pattern determined by the UE 404, wherein the at least one desired cell DRX pattern associates with at least one of a cell DRX pattern index, a cell DRX start offset, a desired cell DRX cycle, a desired cell DRX ON duration. In one embodiment, the UE 404 is configured to measure a communication delay such as a packet delivery delay, and compare the measured communication delay to a first predetermined delay threshold. If the measured communication delay is larger than the first predetermined delay threshold, the UE 404 may determine a desired cell DRX pattern with a longer desired cell DRX ON duration than a predetermined nominal cell DRX ON duration to reduce communication delay and improve communication efficiency. In another embodiment, if the measured communication delay is shorter than the first predetermined delay threshold, the UE 404 may determine a desired cell DRX pattern with a shorter desired cell DRX ON duration than the predetermined nominal cell DRX ON duration to save power.

In some embodiments, the second signal 406 further comprises at least one of: a wake up indication, a cell DRX pattern indication, a cell DTX/DRX pattern indication, a timer triggering indication, a signal transmission indication. In some embodiments, the second signal 406 further comprises UE assistance information, wherein the UE assistance information comprises at least one of: a latency delay requirement, a preferred cell DRX pattern, and a preferred cell DTX/DRX pattern.

In some embodiments, the second signal 406 is carried by at least one of a physical random access channel (PRACH) preamble-based signal, a physical uplink control channel (PUCCH) configuration, a scheduling request (SR), a buffer status report (BSR), a physical uplink shared channel (PUSCH) configuration, and a sequence or preamble based signal.

In some embodiments, the second signal is a PRACH preamble based signal. The second signal is associated with at least one of a preamble format; a sequence generation method; a time domain resource allocation; a frequency domain resource allocation; a preamble index; a cell DRX pattern index; or a cell DTX/DRX pattern index. For some examples, the preambles used for random access and the preambles used as a second signal can be distinguished by the preamble format. For some other examples, the preambles used for random access and the preambles used as a second signaling can be distinguished by the sequence generation method, which includes at least one of cycling shift, sequence initialization, root sequences. For some other examples, each preamble associate with one preamble index, and one or more preambles associated with pre-defined indexes are used as the second signal. In some other examples, the second signaling is used to indicate a cell DRX pattern or a cell DTX/DRX pattern. There are one or more preambles used for cell DRX pattern or cell DTX/DRX pattern indication, and each preamble associated with one cell DRX pattern or one cell DTX/DRX pattern. The gNB receives the preamble, and acquire the cell DRX pattern indication or the cell DTX/DRX pattern indication.

In some embodiments, the second signal is carried by a PUCCH. The second signal is associated with at least one of a PUCCH format; a PUCCH resource ID; a PUCCH resource set ID; a UCI length. In some examples, the second signal is configured with a pre-defined PUCCH format. At least one of the initialCyclicShift, nrofSymbols, startingSymbolIndex are different with the PUCCH used for HARQ-ACK, SR and CSI report. In some other examples, the second signal is configured with one or more PUCCH resource with specific resource ID. In some other examples, the second signal is configured with one or more PUCCH resource set with specific resource set ID.

In some embodiments, the second signal is a SR(Scheduling Request). When a SR requesting UL-SCH resources for new transmission, a wake up indication information or an timer triggering information for cell DRX or cell DTX/DRX is transmitted.

In some embodiments, the second signaling is a BSR. When a BSR with information about UL data volume is transmitted, a wake up indication information or an timer triggering information for cell DRX or cell DTX/DRX is transmitted.

In some embodiments, the second signaling is carried by a PUSCH.

In some embodiments, the second signaling is a sequence or preamble based signal, comprising at least one of a binary sequence or preamble; a sequence or preamble modulated with OOK, ASK, FSK; a sequence or preamble and a data or payload part.

In some embodiments, the UE 404 is configured to measure a communication delay such as a packet delivery delay, and compare the measured communication delay to a second predetermined delay threshold, wherein the second predetermined delay threshold is larger than the first predetermined delay threshold. If the measured communication delay is larger than the second predetermined delay threshold, the UE 404 may determine that the communication quality is not acceptable and cell DTX/DRX may not be used in order to maintain the communication quality. In such as case, the UE 404 may indicate not starting the cell DRX ON duration timer or the cell DTX/DRX ON duration timer. In some embodiments, the wake up indication is used to indicate at least one of: starting a cell DRX ON duration timer based on a desired DRX cycle, starting a cell DTX/DRX ON duration timer based on a desired DTX/DRX cycle, not starting a cell DRX ON duration timer, and not starting a cell DTX/DRX ON duration timer.

In some embodiments, the second signal comprises an indication to indicate starting a cell DRX ON duration timer. UE does not send second signal when there is no need to start a cell DRX ON duration timer. In some embodiments, UE sends the second signal to indicate starting a cell DTX/DRX ON duration timer. UE does not send second signaling when there is no need to start a cell DTX/DRX ON duration timer.

In some embodiments, the wake up indication comprises a “0” value and a “1” value, wherein the “0” value indicates not starting the cell DRX ON duration timer, and the “1” value indicates starting the cell DRX ON duration timer. In some other embodiments, the wakeup indication comprises a “0” value and a “1” value, wherein the “0” value indicates not starting the cell DTX/DRX ON duration timer, and the “1” value indicates starting the cell DTX/DRX ON duration timer.

In some embodiments, the second signal 406 is a sequence-based signal such as a preamble-based signal. In one embodiment, the second signal 406 comprises a plurality of second signal sequences, wherein each of the plurality of second signal sequences is associated with one corresponding cell DRX pattern or one corresponding cell DTX/DRX pattern. In some other embodiments, the second signal 406 is a channel-based signal carried by a PUCCH or a PUSCH. In one exemplary embodiment, the second signal 406 comprises a sequence of 3 bitstreams: bitstream 1, bitstream 2, and bitstream 3, wherein bitstream 1 comprises a first plurality of bits representing a cell DRX cycle, bitstream 2 comprises a second plurality of bits representing a cell DRX ON duration, and bitstream 3 comprises a third plurality of bits representing a cell DRX inactivity duration.

In some embodiments, the second signal 406 comprises a cell DRX pattern indication field or a cell DTX/DRX pattern indication field, wherein the cell DRX pattern indication field or the cell DTX/DRX pattern indication field is a bitmap, wherein each bit in the bitmap corresponds to a cell DRX pattern or a cell DTX/DRX pattern. In one embodiment, each bit in the bitmap may be a “1” value for the cell DRX pattern indication or the cell DTX/DRX pattern indication, or a “0” value for the cell DRX pattern indication or the cell DTX/DRX pattern indication, wherein the “1” value indicates the corresponding cell DRX pattern or the corresponding cell DTX/DRX pattern is available or preferred, and the “0” value indicates the corresponding cell DRX pattern or the corresponding cell DTX/DRX pattern is unavailable or not preferred. In some other embodiments, the cell DRX pattern indication field or the cell DTX/DRX pattern indication field is a code point used to indicate a preferred cell DRX pattern index or a preferred cell DTX/DRX pattern index. In one exemplary embodiment, the second signal 406 comprises 3 code points: code point 1, code point 2, and code point 3, wherein the code point 1 comprises a first plurality of American Standard Code for Information Interchange (ASCII) codes representing a cell DRX cycle, the code point 2 comprises a second plurality of ASCII codes representing a cell DRX ON duration, and code point 3 comprises a third plurality of ASCII codes representing a cell DRX inactivity duration.

In some embodiments, the gNB determines the cell DRX pattern to be used in accordance with the second signal information reported by the UEs configured with the same cell DRX pattern. In some embodiments, the gNB determines the cell DTX/DRX pattern to be used in accordance with the second signal information reported by the UEs configured with the same cell DTX/DRX pattern.

In some embodiments, UE comply with the updated cell DRX pattern or cell DTX/DRX pattern after receiving the feedback of the second signaling from the gNB. In some examples, the updated cell DRX pattern or cell DTX/DRX pattern takes effect after receiving the signaling from the gNB, wherein the signaling comprises at least one of a RRC, a DCI, a feedback of the second signaling. In some examples, the updated cell DRX pattern or cell DTX/DRX pattern takes effect after receiving the signaling from the gNB for a period of time, wherein the signaling comprises at least one of a RRC, a DCI, a feedback of the second signaling, the period of time is an offset configured by RRC or pre-defined. In some other examples, the updated cell DRX pattern or cell DTX/DRX pattern takes effect from the next cell DRX ON duration after receiving the signaling from the gNB, wherein the signaling comprises at least one of a RRC, a DCI, a feedback of the second signaling.

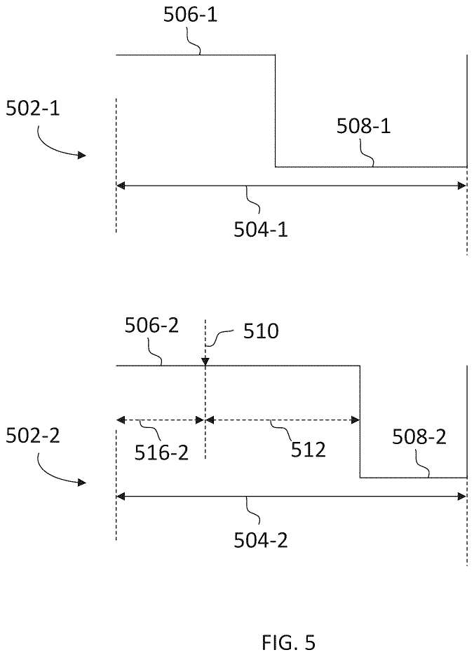

FIG. 5 illustrates an example of a cell DRX inactivity timer used in a cell DRX pattern, in accordance with some embodiments. In some embodiment, the UE 404 shown in FIG. 4 may be configured with a first cell DRX pattern 502-1. When the cell DRX inactivity timer is configured by RRC, the cell DRX inactivity timer can be triggered to extend the cell DRX ON duration. The cell DRX inactivity timer can be triggered by a UE 404. The UE 404 may acquire the information that: the communication quality is not acceptable; an uplink service burst occurs, a DRX ON duration 506-1 in the first cell DRX pattern 502-1 is not long enough; and the DRX ON duration 506-1 needs to be extended to improve communication quality. In such a case, the UE 404 may trigger a cell DRX inactivity timer at a time point 510 in a second cell DRX pattern 502-2 when a time duration 516-2 has elapsed in a cell DRX ON duration 506-2 from the second cell DRX pattern 502-2, wherein the cell DRX inactivity timer is associated with a timer duration 512. The sum of the time duration 516-2 and the timer duration 512 may be larger than the cell DRX ON duration 506-1. Therefore, when the cell DRX inactivity timer is triggered at time point 510, the cell DRX ON duration 506-1 may be extended to the cell DRX ON duration 506-2, and a cell DRX OFF duration 508-2 in the second cell DRX pattern 502-2 becomes shorter than a cell DRX OFF duration 508-1 in the first cell DRX pattern 502-1. In some embodiments, the cell DRX inactivity timer is configured for a specific UE. In some other embodiments, the cell DRX inactivity timer is configured for a group of UEs within a cell covered by the BS.

In some embodiments, the second signal comprises a timer triggering indication. The timer triggering indication is used to indicate starting or restarting a cell DRX inactivity timer, or starting or restarting a cell DTX/DRX inactivity timer, to stop a cell DRX inactivity timer, to stop a cell DTX inactivity time. In some examples, the cell DRX inactivity timer is a UE specific timer. In some examples, UE starts or restarts the cell DRX inactivity timer after sending the second signaling. In some other examples, UE starts or restarts the cell DRX inactivity timer after receiving the feedback of the second signaling from the gNB. In some other examples, the cell DRX inactivity timer is configured for a group UE or all the UE configured with a same cell DRX pattern. In some other examples, UE starts or restarts the cell DRX inactivity timer after receiving the feedback of the second signaling from the gNB. In some examples, the cell DTX/DRX inactivity timer is a UE specific timer. In some examples, UE starts or restarts the cell DTX/DRX inactivity timer after sending the second signaling. In some other examples, UE starts or restarts the cell DTX/DRX inactivity timer after receiving the feedback of the second signaling from the gNB. In some other examples, the cell DTX/DRX inactivity timer is configured for a group UE or all the UE configured with a same cell DTX/DRX pattern. In some other examples, UE starts or restarts the cell DTX/DRX inactivity timer after receiving the feedback of the second signaling from the gNB.

In some embodiments, the second signaling comprises a time offset/duration indication, wherein the time offset/duration is used to indicate when to start or restart a timer, including a cell DRX ON duration timer, a cell DTX/DRX ON duration timer, a cell DRX inactivity timer, a cell DTX/DRX inactivity timer. In some embodiments, the second signaling comprises a time offset/duration indication, wherein the time offset/duration is used to indicate the (remainder) time for UE sending UL signal/channel

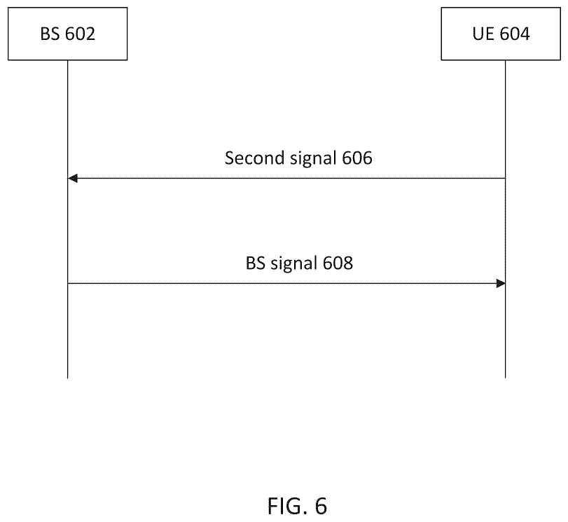

FIG. 6 illustrates another signaling diagram between a BS 602 and a UE 604 for performing cell DTX/DRX signal processing, in accordance with some embodiments. In some embodiments, upon receiving the second signal 606, the BS 602 determines that at least one cell DRX pattern or at least one cell DTX/DRX pattern can be used based on the second signal 606, wherein the second signal 606 is reported and transmitted by the UE 604 to request the at least one cell DRX pattern or the at least one cell DTX/DRX pattern. In response to receiving the second signal 606, the BS 602 determines whether to grant the at least one cell DRX pattern or the at least one cell DTX/DRX pattern requested by the UE 604, and thereafter transmits the BS signal 608 indicating whether the request is granted or not granted. In accordance with various embodiments, The BS 602 can determine whether to grant or partially grant the request based on various factors such as available bandwidth, available resources, QoS parameters associated with each UE 604, etc. Upon receiving the BS signal 608, the UE 604 configures the timing of future signaling in accordance with the updated cell DRX pattern or the updated cell DTX/DRX pattern as indicated by the BS signal 608 received from the BS 602. In accordance with some embodiments, the BS signal 608 comprises at least one of: a radio resource control (RRC) signal, a downlink control information (DCI) signal, and a feedback signal of the second signal 606. In some embodiments, the updated cell DRX pattern or the updated cell DTX/DRX pattern takes effect a period of time after receiving the BS signal 608, wherein the BS signal 608 comprises at least one of: an RRC, a DCI signal, and a feedback signal of the second signal 606, wherein the period of time is an offset configured by RRC or pre-defined. In some other embodiments, the updated cell DRX pattern or the updated cell DTX/DRX pattern takes effect from the next cell DRX ON duration after receiving the BS signal from the BS 602, wherein the BS signal 608 comprises at least one of: an RRC signal, a DCI signal, and a feedback signal of the second signal 606.

In some embodiments, the feedback signal is the first signal comprises at least one of: a RRC signaling, a media access control (MAC) control element (CE), a DCI signal, and a low power wake up signal (LP-WUS). In some embodiments, the LP-WUS signal comprises at least one of: a preamble, a data part, and a cyclic redundancy check (CRC) attachment. In some embodiments, the UE 604 is configured to update a plurality of UE configurations based on the feedback signal, wherein the feedback signal comprises at least one of: a cell DTX/DRX pattern indication, a cell DRX pattern indication, a timer indication, wherein the timer comprises at least one of a cell DRX ON duration timer, a cell DRX inactivity timer, a cell DTX/DRX ON duration timer, a cell DTX/DRX inactivity timer.

In some embodiments, the UE 604 detects the feedback signal in accordance with the currently configured cell DRX cycle. In one embodiment, a feedback occasion to transmit the feedback signal is determined by at least one of: a start of a cell DRX ON duration, a third offset between the start of a second signal occasion and the start of a cell DRX ON duration, the end of a cell DRX ON duration, a fourth offset between the start of the second signal occasion and the end of a cell DRX ON duration, a second signal occasion, a fifth offset between the start of the second signal occasion and the start of a feedback occasion.

In some embodiments, the UE 604 detects the feedback signal in accordance with the currently configured cell DTX/DRX cycle. In one embodiment, a feedback occasion to transmit the feedback signal is determined by at least one of: a start of a cell DTX/DRX ON duration, an offset between the start of a second signal occasion and the start of a cell DTX/DRX ON duration, the end of a cell DTX/DRX ON duration, an offset between the start of the second signal occasion and the end of a cell DTX/DRX ON duration, a second signal occasion, an offset between the start of the second signal occasion and the start of a feedback occasion.

In some other embodiments, the UE 604 detects the feedback signal after sending the second signal 606. The UE 604 may detect the feedback signal a period of time after sending the second signal 606, wherein the period of time is at least one of: pre-defined, a fixed value, and configured by RRC. In some embodiments, the period of time is set by the BS 602 to ensure that the UE 604 receives the feedback signal on time.

In some embodiments, the timer triggering indication contained in the second signal 406/606 is used to indicate starting or restarting a cell DRX inactivity timer, or starting or restarting a cell DTX/DRX inactivity timer. In one embodiment, the cell DRX inactivity timer is a UE-specific timer. In some embodiments, the UE 404/604 starts or restarts the cell DRX inactivity timer after sending the second signal 406/606. In some other embodiments, the UE 404/604 starts or restarts the cell DRX inactivity timer after receiving a feedback signal of the second signal 406/606 from the BS 402/602. In yet some other embodiments, the cell DRX inactivity timer is configured for a group of UEs or all the UEs configured with a same cell DRX pattern.

In some embodiments, the cell DTX/DRX inactivity timer is a UE-specific timer. In one embodiment, the UE 604 starts or restarts the cell DTX/DRX inactivity timer after sending the second signal 606. In another embodiment, the UE 604 starts or restarts the cell DTX/DRX inactivity timer after receiving a feedback signal of the second signal 606 from the BS 602. In yet another embodiment, the cell DTX/DRX inactivity timer is configured for a group UEs or all the UEs configured with a same cell DTX/DRX pattern. In some embodiments, the second signal 606 comprises a time offset and duration indication, wherein the time offset and duration indication is used to indicate when to start or restart a timer, including a cell DRX ON duration timer, a cell DTX/DRX ON duration timer, a cell DRX inactivity timer, and a cell DTX/DRX inactivity timer. The purpose of the DTX/DRX inactivity timer is similar to the DRX inactivity timer, as discussed above.

In some embodiments, the second signal comprises a signal transmission indication to indicate a third signal to transmit and/or a third signal not to transmit. The third signal may comprise at least one of: a PUCCH, a PUSCH, a hybrid automatic repeat request (HARQ)-acknowledgement (ACK) feedback, a channel state information (CSI) report, a sounding reference signal (SRS), a configured grant physical uplink shared channel (CG-PUSCH). In some embodiments, the UE is configured with a current DRX pattern, and the UE may not need to update the DRX pattern for a specific time period, then the signal transmission indication may indicate the specific time period in which the third signal is not transmitted by the UE. In some embodiments, the specific time period is associated with at least one of the following: a next cell DRX cycle, a next cell DTX/DRX cycle, a time period configured by RRC signaling, a time duration associated with the cell DRX or the cell DTX/DRX ON duration, a cell DRX inactivity timer, a cell DTX/DRX inactivity timer, a UE connected mode discontinuous reception (CDRX) on duration timer or inactivity timer, and a UE CDRX retransmission timer or round-trip timer (RTT) timer for UL.

In some embodiments, the second signaling comprises a signal transmission indication to indicate a forth signal to receive and/or a fourth signal not to receive, wherein the fourth signal comprises at least one of the followings: a PDCCH, a PDSCH, a semi-persistent scheduling (SPS), a channel status information reference signal (CSI-RS), a semi-persistent CSI-RS, an aperiodic CSI-RS, a remote interference management reference signal (RIM-RS), a positioning reference signal (PRS), a synchronization signal physical broadcast channel (SS/PBCH) block, a phase-tracking reference signal (PT-RS), a secondary synchronization signal (SSS), and a primary synchronization signal (PSS). In accordance with various embodiments, the fourth signal is used by the UE to monitor and maintain the quality of communication between the BS and the UE.

In some other embodiments, to reduce power consumption, the signal transmission indication may indicate a specific time period for not receiving the fourth signal. In some embodiments, the specific time period comprises at least one of the followings: a next cell DTX cycle, a next cell DTX/DRX cycle, a time period configured by RRC signaling, a time duration associated with the cell DTX or the cell DTX/DRX ON duration, a cell DTX inactivity timer, a cell DTX/DRX inactivity timer, a UE CDRX on duration timer or inactivity timer, and a UE CDRX retransmission timer RTT timer for DL.

In some embodiments, the plurality of second signal transmission occasions is associated with at least one of: a random access channel (RACH) occasion, a cell DRX configuration, a cell DTX/DRX configuration, a start point and a periodicity, and a time window. The purpose of the plurality of second signal transmission occasions is to specify the conditions under which the second signal is transmitted by the UE, such that the UE can transmit the second signal at specific times with available resources. In some embodiments, when at least one of the plurality of second signal transmission occasions is associated with the RACH occasion, the at least one of the plurality of second signal transmission occasions may be the same as the RACH occasion, part of the RACH occasion, or close to the RACH occasion.

In some embodiments, when at least one of the plurality of second signal transmission occasions is associated with the cell DRX configuration, the at least one of the plurality of second signal transmission occasions may be determined by at least one of: a start of a cell DRX ON duration, a first offset between the start of the at least one of the plurality of second signal transmission occasions and the start of the cell DRX ON duration, an end of the cell DRX ON duration, a second offset between the start of the at least one of the plurality of second signal transmission occasions and the end of the cell DRX ON duration.

In some embodiments, when at least one of the plurality of second signal transmission occasions is associated with the cell DTX/DRX configuration, the at least one of the plurality of second signal transmission occasions may be determined by at least one of: a start of a cell DTX/DRX ON duration, a first offset between the start of the at least one of the plurality of second signal transmission occasions and the start of the cell DTX/DRX ON duration, an end of the cell DTX/DRX ON duration, a second offset between the start of the at least one of the plurality of second signal transmission occasions and the end of the cell DTX/DRX ON duration.

In some embodiments, when at least one of the plurality of second signal transmission occasions is associated with the start point and the periodicity of at least one subframe transmitted from the UE to the BS, the at least one of the plurality of second signal transmission occasions may be configured by a parameter set, comprising the start point and the periodicity.

In some embodiments, when at least one of the plurality of second signal transmission occasions is associated with the time window, wherein the time window indicates duration and time of at least one subframe transmitted from the UE to the BS, the time window may comprise at least one of: a start point, an offset, and a periodicity.

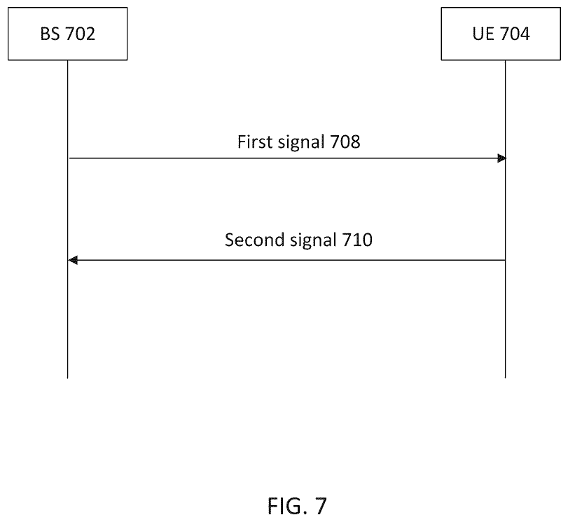

FIG. 7 illustrates another signaling diagram between a BS 702 and a UE 704 for performing DTX/DRX signal processing, in accordance with some embodiments. In some embodiments, the BS 702 is configured to transmit a first signal 708 to the UE 704, and then UE 704 is configured to transmit a second signal 710 to the BS 702. In accordance with various embodiments, the first signal 708 contains one or more of the different types of configuration information described above. The functions of the first signal 708 and the configuration information contained therein, and the second signal 710 are described above with reference to FIGS. 2 and 5, and are, therefore, not repeated here.

In some embodiments, the second signal 710 comprises at least one of: a request for cell DRX pattern from the UE 704, and a request for cell DTX/DRX pattern from the UE 704. Upon receiving the second signal 710, the BS 702 may determine to accept or reject the request for cell DRX pattern and/or the request for cell DTX/DRX pattern based on at least one of the followings: requests for DRX patterns from other UEs within the same cell where the UE 704 is located; requests for DTX/DRX patterns from other UEs within the same cell where the UE 704 is located; available transmission resources, and one or more resource configurations.

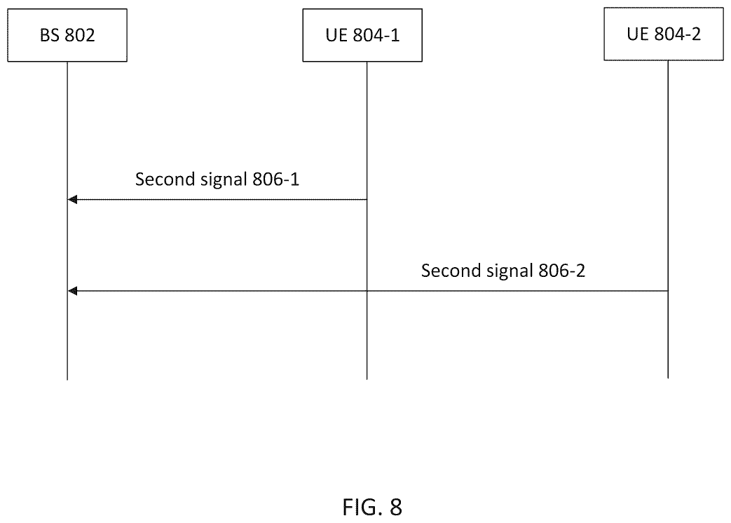

FIG. 8 illustrates yet another signaling diagram between a BS 802 and two UEs 804-1 and 804-2 for performing DTX/DRX signal processing, in accordance with some embodiments. In some embodiments, the UEs 804-1 and 804-2 are within a same cell covered by the BS 802. Although two UEs are shown in the example in FIG. 8, the BS 802 may be in communication with and serve any number of UEs within the same cell covered by the BS 802. In some embodiments, the UE 804-1 is configured to transmit a second signal 806-1 to the BS 802, and the UE 804-2 is configured to transmit a second signal 806-2 to the BS 802. The functions of the second signals 806-1 and 806-2 are described above with reference to FIG. 5, and are, therefore, not repeated here.

In some embodiments, the second signal 806-1 comprises at least one of: a request for cell DRX pattern from the UE 804-1, and a request for cell DTX/DRX pattern from the UE 804-1. Upon receiving the second signal 806-1, the BS 802 may determine to accept or reject the request for cell DRX pattern and/or the request for cell DTX/DRX pattern based on at least one of the followings: requests for DRX patterns included in the second signal 806-2 from the UE 804-2; requests for DTX/DRX patterns included in the second signal 806-2 from the UE 804-2; available transmission resources, quality of service (QoS) requirements, available bandwidth, and one or more resource configurations.

In some embodiments, the BS 802 receives a plurality of second signals from a plurality of UEs within a cell covered by the BS 802, wherein each of the second signals is transmitted by a corresponding each of the plurality of UEs, and each of the second signals is associated with a corresponding each of a plurality of desired cell DRX patterns. The BS 802 may be then configured to accept at least one of the plurality of desired cell DRX patterns based on at least one of: information of the plurality of second signals, available transmission resources, quality of service (QoS) requirements, available bandwidth, and one or more resource configurations. In some other embodiments, the BS 802 may be configured to reject some or all of the plurality of desired cell DRX patterns based on at least one of: information of the plurality of second signals, available transmission resources, quality of service (QoS) requirements, available bandwidth, and one or more resource configurations.

In some embodiments, UE detects the feedback after sending a second signal. In some embodiments, UE detects the feedback per cell DRX cycle. In some examples, the feedback occasion is determined by at least one of a start of cell DRX ON duration, a third offset between the start of second signaling occasion and the start of cell DRX ON duration, an end of cell DRX ON duration, a fourth offset between the start of second signaling occasion and the end of cell DRX ON duration, a second signaling occasion, a fifth offset between the start of second signaling occasion and the start of the feedback occasion. In some embodiments, UE detects the feedback per cell DTX/DRX cycle. The feedback occasion is determined by at least one of a start of cell DTX/DRX ON duration, an offset between the start of second signaling occasion and the start of cell DTX/DRX ON duration, an end of cell DTX/DRX ON duration, an offset between the start of second signaling occasion and the end of cell DTX/DRX ON duration, a second signaling occasion, an offset between the start of second signaling occasion and the start of the feedback occasion. In some other embodiments, UE detects the feedback after sending the second signaling. The UE detects the feedback after sending the second signaling for a period of time, wherein the period of time is determined by at least one of pre-defined, a fixed value or configured by RRC.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, module, etc. can be configured to perform one or more of the functions described herein. The term “configured to” or “configured for” as used herein with respect to a specified operation or function refers to a processor, device, component, circuit, structure, machine, module, etc. that is physically constructed, programmed and/or arranged to perform the specified operation or function.

Furthermore, a person of ordinary skill in the art would understand that various illustrative logical blocks, modules, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

1. A method performed by a wireless communication device, the method comprising:
receiving a first signal from a first wireless communication node;
second signal comprises at least one of:
a wake up indication;
a cell discontinuous reception (DRX) pattern indication indicating a preferred cell DRX pattern;
a cell discontinuous transmission (DTX) cell DRX pattern indication indicating a preferred cell DTX/DRX pattern;
a timer triggering indication;
a signal transmission indication; and
a latency delay requirement.

2. The method of claim 1, wherein the first signal comprises at least one of:
a radio resource control (RRC) signal;
a downlink control information (DCI) signal;
a media access control (MAC) control element (CE) signal; and
a low power wake up signal (LP-WUS), wherein the LP-WUS signal comprises at least one of: a preamble; a data part; and a cyclic redundancy check (CRC) attachment.

3. The method of claim 1, wherein the first signal is a feedback signal from the first wireless communication node in response to the second signal.

4. The method of claim 1, wherein the first signal comprises configuration information, wherein the configuration information comprises at least one of:
one or more cell DTX patterns, wherein each of the one or more cell DTX patterns comprise at least one of: a cell DTX start offset, a cell DTX cycle, a cell DTX ON duration timer, and a cell DTX inactivity timer;
one or more cell DRX patterns, wherein each of the one or more cell DRX patterns comprise at least one of: a cell DRX start offset, a cell DRX cycle, a cell DRX ON duration timer, and a cell DRX inactivity timer; and
one or more cell DTX/DRX patterns, wherein each of the one or more cell DTX/DRX patterns comprise at least one of: a cell DTX/DRX start offset, a cell DTX/DRX cycle, a cell DTX/DRX ON duration timer associated with a cell DTX/DRX ON duration, and a cell DTX/DRX inactivity timer.

5. The method of claim 1, wherein the first signal further comprises indication information including at least one of:
activating and/or deactivating a cell DTX pattern for a group of wireless communication devices;
activating and/or deactivating a cell DRX pattern for a group of wireless communication devices;
an information block carrying information for a wireless communication device of a group of wireless communication devices, wherein the information comprises a wake-up indication, a signal transmission indication, a timer triggering indication, a resource parameter, a flag indicating whether the one or more fields in the DCI are reinterpreted or an indication indicating a type of a power offset to be used, a field to indicate selected power offsets, a field to indicate one or more updated CSI resources, a field to indicate a start offset of a cell DTX/DRX cycle, or user equipment, UE, connected mode discontinuous reception, CDRX, configuration related information, a field to indicate a number of ports used for at least one of a CSI measurement or a CSI report, one or more CSI-RS resource identifiers, one or more CSI-RS resource set identifiers, one or more CSI-ResourceConfig identifiers, and a field to indicate the activation or deactivation of the TCI states in the TCI state set; wherein the resource parameter includes at least one of
the number of ports, port indices indication, group indication, power offset, an index, TCI (transmission configuration indicator), CDM (code division multiplexing), resource mapping, CDM group index, frequency domain resource, time domain resource, a group index.

6. The method of claim 1, wherein the first signal is transmitted when at least one of the following conditions is met:
a wireless communication device supports UE capability of cell DTX;
a wireless communication device supports UE capability of cell DRX;
a cell DRX pattern will be changed;
a cell DTX pattern will be changed;
a second signal is transmitted by a wireless communication device or received by a wireless communication node;
a cell DTX/DRX pattern will be changed;
a start offset is changed, wherein the start offset comprises at least one of a cell DTX start offset, a cell DRX start offset, a cell DTX/DRX start offset; and
a timer will be activated, wherein the timer comprises at least one of: a cell DTX on duration timer; a cell DTX inactivity timer; a cell DRX on duration timer; a cell DRX inactivity timer; a cell DTX/DRX on duration timer; and a cell DTX/DRX inactivity timer.

7. The method of claim 1, wherein the second signal comprises at least one of:
a physical random access channel (PRACH) preamble based signal;
a physical uplink control channel (PUCCH);
a scheduling request (SR);
a buffer status report (BSR);
a sequence or preamble based signal.

8. The method of claim 7, wherein the PRACH preamble based signal is associated with at least one of:
a preamble format;
a sequence generation method;
a preamble index;
a cell DRX pattern index; and
a cell DTX/DRX pattern index.

9. The method of claim 1, wherein the second signal is received on a plurality of second signal transmission occasions, wherein the plurality of second signal transmission occasions is associated with at least one of:
a random access channel (RACH) occasion;
a cell DRX configuration;
a cell DTX/DRX configuration;
a start point and a periodicity; and
a time window, wherein the time window is associated with at least one of a start point, an offset, or a periodicity.

10. The method of claim 1, wherein the wake up indication comprises at least one of:
a first indication for starting a cell DRX on duration timer;
a second indication for starting a cell DTX/DRX on duration timer;
a third indication for not starting the cell DRX on duration timer; and
a fourth indication for not starting the cell DTX/DRX on duration timer.

11. The method of claim 1, wherein the second signal further comprises at least one of:
a cell DRX pattern indication field, wherein the cell DRX pattern indication field comprises a first bitmap comprising a first plurality of bits, wherein each of the first plurality of bits is associated with a corresponding first cell DRX pattern; and
a cell DTX/DRX pattern indication field, wherein the cell DTX/DRX pattern indication field comprises a second bitmap comprising a second plurality of bits, wherein each of the second plurality of bits is associated with a corresponding first cell DTX pattern or a corresponding second DRX pattern.

12. The method of claim 1, wherein the timer triggering indication comprises at least one of:
an indication to indicate to start a cell DRX inactivity timer;
an indication to indicate to restart a cell DRX inactivity timer;
an indication to indicate to start a cell DTX/DRX inactivity timer;
an indication to indicate to restart a cell DTX/DRX inactivity timer;
an indication to indicate to stop a cell DRX inactivity timer;
an indication to indicate to stop a cell DTX inactivity timer.

13. The method of claim 1, wherein the signal transmission indication comprises at least one of:
an indication to indicate to transmit a third signal;
an indication to indicate not to transmit a third signal;
an indication to indicate to receive a fourth signal;
an indication to indicate not to receive a fourth signal; wherein the third signal comprises at least one of: a PUCCH, a physical uplink shared channel (PUSCH), a hybrid automatic repeat request acknowledgement (HARQ-ACK), a channel state information (CSI) report, a sounding reference signal (SRS), a Configured Grant Physical Uplink Shared Channel (CG-PUSCH); and
wherein the fourth signal comprises at least one of: a PDCCH, a PDSCH, a semi-persistent scheduling (SPS), a CSI reference signal (CSI-RS), a semi-persistent CSI-RS, an aperiodic CSI-RS, a remote interference management reference signal (RIM-RS), a positioning reference signal (PRS), a synchronization signal physical broadcast channel (SS/PBCH) block, a phase-tracking reference signal (PT-RS), a secondary synchronization signal (SSS), a primary synchronization signal (PSS).

14. A method performed by a wireless communication node, the method comprising:
transmitting a first signal to one wireless communication device or a plurality of wireless communication devices;
receiving a second signal from the wireless communication device, wherein the second signal comprises at least one of:
a wake up indication;
a cell discontinuous reception (DRX) pattern indication indicating a preferred cell DRX pattern;
a cell discontinuous transmission (DTX) cell DRX pattern indication indicating a preferred cell DTX/DRX pattern;
a timer triggering indication;
a signal transmission indication; and
a latency delay requirement.

15. (canceled)

16. The method of claim 14, wherein the first signal is a feedback signal from the first wireless communication node in response to the second signal.

17-19. (canceled)

20. The method of claim 14, wherein the second signal comprises at least one of:
a physical random access channel (PRACH) preamble based signal;
a physical uplink control channel (PUCCH);
a scheduling request (SR);
a buffer status report (BSR);
a sequence or preamble based signal.

21-22. (canceled)

23. The method of claim 14, wherein the wake up indication comprises at least one of:
a first indication for starting a cell DRX on duration timer;
a second indication for starting a cell DTX and DRX on duration timer;
a third indication for not starting the cell DRX on duration timer; and
a fourth indication for not starting the cell DTX and DRX on duration timer.

24-25. (canceled)

26. The method of claim 14, wherein the signal transmission indication comprises at least one of:
an indication to indicate to transmit a third signal;
an indication to indicate not to transmit a third signal;
an indication to indicate to receive a fourth signal;
an indication to indicate not to receive a fourth signal; wherein the third signal comprises at least one of: a PUCCH, a physical uplink shared channel (PUSCH), a hybrid automatic repeat request acknowledgement (HARQ-ACK), a channel state information (CSI) report, a sounding reference signal (SRS), a Configured Grant Physical Uplink Shared Channel (CG-PUSCH); and
wherein the fourth signal comprises at least one of: a PDCCH, a PDSCH, a semi-persistent scheduling (SPS), a CSI reference signal (CSI-RS), a semi-persistent CSI-RS, an aperiodic CSI-RS, a remote interference management reference signal (RIM-RS), a positioning reference signal (PRS), a synchronization signal physical broadcast channel (SS/PBCH) block, a phase-tracking reference signal (PT-RS), a secondary synchronization signal (SSS), a primary synchronization signal (PSS).

27-30. (canceled)

31. A non-transitory computer-readable medium storing computer-executable instructions that when executed by a computer perform a method according to claim 1.

32. A non-transitory computer-readable medium storing computer-executable instructions that when executed by a computer perform a method according to claim 14.
